(19) United States
(12) Patent Application Publication
(10) Pub. No.: US 2012/0068437 A1
(43) Pub. Date: Mar. 22, 2012

(54) COUPLER HEAD OF A COUPLING DEVICE FOR MECHANICALLY CONNECTING TWO UNITS, PARTICULARLY VEHICLE UNITS

(75) Inventors: Siegfried Kobert, Holle (DE); Martin Wolfgang Meyer, Pforzheim (DE); Sanja Kahl, Hochdorf (DE)

(73) Assignee: VOITH PATENT GMBH, Heidenheim (DE)

(21) Appl. No.: 13/234,926

(22) Filed: Sep. 16, 2011

(30) Foreign Application Priority Data
Sep. 20, 2010 (EP) 10177684.7
Jan. 25, 2011 (EP) 11151962.5

(51) Int. Cl. B60D 1/64

(52) U.S. Cl. 280/421; 280/422

(57) ABSTRACT

A coupler head of a coupling device for mechanically connecting two units is provided. The coupler head comprises at least one coupler lock to form a mechanical connection with a coupler lock of a counter-coupler head, and an electrical contact coupling for the coupling of at least one electrical line between the coupler head and the counter-coupler head. The coupler head further comprises a base body to which the coupler lock and the electrical contact coupling are mounted, so as to enable the coupler head to be universally applicable for a plurality of applications and in particular for it to be operated as low-maintenance as possible. A coupler head housing accommodates the base body with the at least one coupler lock and electrical contact coupling. The base body further comprises a linkage to which a coupling shaft is articulated so as to be pivotable in a horizontal and/or vertical plane.

### CROSS-REFERENCE TO RELATED APPLICATIONS

This application claims priority to European Application Nos. EP 10 177 684.7 filed Sep. 20, 2010 and EP 11 15 1962.5 filed Jan. 25, 2011, both of which are incorporated by reference herein in their entirety.

### BACKGROUND

1. Field of Invention

The invention relates to a coupler head in accordance with the precharacterizing part of independent claim 1.

The invention accordingly relates in particular to a coupler head having at least one coupler lock to establish a mechanical connection with a coupler lock of a counter-coupler head as well as an electrical contact coupling to couple at least one electrical line between the coupler head and the counter-coupler head. A coupler head of this type is particularly suited to forming a mechanical connection between two units, particularly vehicle units, such as two adjacent car bodies of a multi-member vehicle train, for example, or to forming a mechanical connection between a pick-up assembly and the cargo area of a motor vehicle. It would furthermore be conceivable to use the coupler head according to the invention to couple for example a snowplow or another exchangeable mount for a motor vehicle.

The use of such a coupler head in a coupling device is generally known in the prior art. In particular, coupler heads of the type cited above are utilized in various embodiments to couple road vehicles. Cited as an example of this are trailer couplings for passenger cars, which are usually realized as ball-hitch couplings in which a hitch affixed to a trailer is positioned over an upright projecting ball-type element and secured in place at that point. In the case of semi-trailer combinations, fifth wheel couplings are normally used to couple tractor trucks and semi-trailers, whereby a downward projecting pin on the semi-trailer is locked in place in a receiver on the tractor truck. Bolt couplings are frequently used between trucks and their trailers whereby an eye usually situated on the trailer drawbar is positioned into a receiver on the truck and secured there by means of bolt.

2. Description of Related Art

Such systems known from the prior art primarily serve in creating purely mechanical connections between the vehicles, whereby for example pneumatic, electrical or hydraulic connections for lighting, brakes, etc., are often formed in a coupling process by manually interlocking cables or hoses. However, manually coupling electrical lines in particular puts the respective contact terminals at the risk of being misaligned and thereby posing a safety hazard to the vehicle and other traffic.

Since the coupling devices known from the prior art furthermore do not usually constitute fixed or rigidly-made systems, there is also the risk of relative movement between the coupler head and the counter-coupler head such that no smooth automatic coupling of particularly electrical lines can be realized. Conventional coupler heads in particular face the risk of longitudinal and transverse movements occurring during the coupling process which need to be correspondingly compensated in order to also enable the problem-free coupling of the electrical lines and above all without any material-stressing electrical arcs occurring at the electrical contact terminals of the respective electrical contact couplings.

While fully automatic coupling systems are known in the field of rail vehicle technology, in which not only a mechanical connection can be made fully automatically between two adjacent car bodies, but also between the electrical contact couplings, such known rail vehicle solutions require accordingly large installation spaces for mounting the electrical contact coupling, normally realized as a separate component from the mechanical coupling, whereby the necessary free space is often not available in actual practice.

On the other hand, it is for example known from the DE 24 14 384 A1 printed publication that to mechanically couple adjacent car bodies of a multi-member rail vehicle, the coupler head is to be implemented in such a manner that the end face of the coupler head comprises a planar front end disposed transverse to the longitudinal axis in the coupling plane which comes into contact with the corresponding abutting surface of the counter-coupler head during the coupling process. A compressed air terminal on or in the abutting surface is thereby further provided to couple a compressed air line.

Yet the principle behind this known prior art assembly in which rigid and slack-free end faces of the respective car bodies abut against one another cannot be readily realized in coupling devices for coupling two units, because there is often no end face or abutting surface provided transverse to the longitudinal axis. Moreover, any coupler head of this design still generally exhibits a certain play during the coupling process such that longitudinal and transverse movements, which need to be correspondingly compensated, cannot be prevented between the respective coupler heads in order to also enable a smooth, problem-free coupling of the electrical contact couplings.

Depending on how the mechanical coupling is designed, there is furthermore a wide range of differently configured cable couplers. For example, the DE 499 955 A printed publication proposes fixedly connecting the electrical contact coupling to the mechanical coupling. Known from the DE 927 445 A publication is implementing the electrical contact coupling so as to be pivotable relative the mechanical coupling. Finally, the DE 24 14 384 A1 printed publication then proposes an electrical contact coupling which is displaceable parallel to the mechanical coupling axis.

The coupler heads in these known prior art couplings comprise a planar end face or abutting surface disposed transverse to the longitudinal axis at their front ends which are utilized by the corresponding abutting surface of the counter-coupling. Data signals and power cables are hereby conveyed by means of electrical contact couplings of project-specific design, also called “E-boxes” in the field of rail vehicle technology. These electrical contact couplings are thereby arranged underneath or to the side of the mechanical couplings.

As a rule, the project-oriented realizations of these electrical contact couplings constitute individual solutions for electrical contact coupling design and configuration. The known solutions are particularly unsuited to a universally applicable coupler head used not only in the field of rail vehicle technology but also in the field of motor vehicle technology to enable fully automatic mechanical coupling as well as coupling of electrical lines between two units which are movable relative one another.

From this problem as posed, the present invention is based on the object of further developing a coupler head of the type cited at the outset to the effect of enabling a fully automated or at least partly automated coupling process involving electrical, optical, pneumatic and/or hydraulic connecting lines, wherein the coupler head is universally applicable and can be used for a wide range of different requirements.

### BRIEF SUMMARY

This object is inventively solved by the subject matter of independent claim 1.

According thereto, the inventive solution provides for a coupler head comprising at least one coupler lock to create a mechanical connection with a coupler lock of a counter-coupler head as well as an electrical contact coupling for the coupling of at least one electrical line between the coupler head and the counter-coupler head. In accordance with the invention, the coupler head further comprises a base body to which the at least one coupler lock and the electrical contact coupling are mounted. The coupler head furthermore comprises a coupler head housing which accommodates the base body with the at least one coupler lock and the electrical contact coupling. It is additionally provided for the base body to comprise a linkage to which a coupling shaft is articulated so as to be pivotable in a horizontal and/or vertical plane.

The advantages which can be achieved with the inventive solution are obvious: providing a coupler head housing to accommodate the at least one coupler lock as well as the electrical contact coupling ensures that all the components of the coupler head which are prone to wear are enclosed within the coupler head housing so that the costs of maintaining the coupler head can be significantly reduced compared to the known prior art coupler heads. The coupler head base body being additionally provided with a linkage, via which the coupler head is pivotable in the horizontal and/or vertical plane relative to a coupling shaft, ensures that the coupler head can form a rigid mechanical connection together with a counter-coupler head, whereby the linkage can compensate any longitudinal and/or transverse movements which may occur as needed. This enables smooth, problem-free coupling of the electrical contacts, whereby particularly material-stressing electrical arcs can also be effectively prevented at the electrical contact terminals. Providing the linkage on the coupler head base body thus suits the inventive coupler head for mechanical coupling in which the electrical connecting cables can also be coupled together either fully automatically or at least in a partly automated process. It is additionally provided for the linkage to be mounted to the coupler head base body, wherein the base body itself is protected from the effects of weather including dirt, ice, etc., by the coupler head housing.

The invention further yields advantages with respect to safety since the coupling process does not require an operator to manually intervene nor step between the objects to be coupled.

The overall compact structure of the coupler head suits it for a plurality of different applications. In particular, the solution according to the invention is suitable for mechanically connecting two adjacent car bodies of a multi-member vehicle train such as, for example, connecting a motor vehicle with a corresponding trailer or connecting two car bodies of a multi-member track-guided vehicle. However, it is of course also conceivable to employ the coupler head in other applications when not only a mechanical connecting of two units is the intent, but also the simultaneous coupling of electrical cables. This is for example the case when coupling a pick-up assembly to the cargo area of a motor vehicle. It would furthermore be conceivable to use the inventive coupler head to couple for example a snowplow or another exchangeable mount to the front of a motor vehicle.

One preferred embodiment provides for the base body to comprise a vertically extending area having a centrally arranged opening on its side opposite from the coupling plane, wherein the coupling shaft extends through this opening so that the opening defines the pivoting range of the coupler head relative the coupling shaft. This constitutes a particularly easily realized solution for defining the pivoting range of the coupler head relative the coupling shaft. As an example, it is conceivable for the vertically extending area of the base body to be configured as a plate which caps off the coupler head housing at its side opposite the coupling plane so as to enable an encapsulating of the components accommodated in the coupler head housing, particularly the coupler lock and the electrical contact coupling. Of course other embodiments for defining the pivoting range of the coupler head relative the coupling shaft are also conceivable.

With respect to the linkage provided on the base body of the coupler head, it is preferable for same to be realized as a spherical bearing by means of which the coupling shaft can be articulated to the base body so as to be pivotable in a horizontal as well as vertical plane relative to the coupler head. Making use of a spherical bearing has the further advantage of allowing torsional movement of the coupling shaft relative the coupler head.

Alternatively to a spherical bearing it is of course also conceivable to make use of a swivel joint for the linkage, by means of which the coupling shaft is articulated to the base body so as to be pivotable either in a horizontal or in a vertical plane relative to the coupler head. As an example, it is conceivable to provide a first swivel joint within the coupler head housing to enable the coupler head to be able to pivot in the horizontal plane relative to the coupling shaft, wherein additionally to the first swivel joint in the coupler head housing, a second swivel joint is provided by means of which the coupler head can pivot in the vertical plane relative to the coupling shaft. Providing two swivel joints to form the linkage allows the coupler head to pivot both in a horizontal as well as in a vertical plane relative the coupling shaft.

On the other hand, it is in principle also conceivable for the linkage to be implemented as a swivel joint which articulates the coupling shaft to the base body so as to be pivotable either in a horizontal or a vertical plane relative to the coupler head, wherein the coupling shaft is of two-piece configuration and comprises a first shaft section as well as a second shaft section connected together by means of an additional articulation. This additional articulation is thereby to enable the pivotability of the coupler head in a vertical or horizontal plane relative the coupling shaft.

In order to achieve the electrical contact coupling being accommodated in fully encapsulated manner in the coupler head housing when in the non-coupled state, and in particular not exposed to the effects of weather, a preferred further development of the inventive solution provides for the electrical contact coupling to be displaceable relative the coupler head housing in the coupling direction of the coupler head so that the electrical contact coupling can be conveyed into its coupling position during the coupling process in which at least one contact pin of the electrical contact coupling is at least partly exposed outside of the coupler head housing. The at least one contact pin of the electrical contact coupling is thereby to be fully situated within the coupler head housing in the electrical contact coupling's retracted state; i.e. in normal position, in order to protect the at least one contact pin from the effects of weather and effectively prevent it from unintentionally coming into contact with e.g. people. In the electrical contact coupling's coupling position, the at least one contact pin of the electrical contact coupling is thereby to be preferably exposed as far outside of the coupler head housing to enable the at least one contact pin to be received in a socket of the electrical contact coupling of a counter-coupler head configured complementary to the contact pin in order to enable a secure coupling of the electrical contact coupling of the coupler head to the electrical contact coupling of the counter-coupler head.

To be understood by the term “coupling position” as used herein is the position or state in which the coupler head or the electrical contact coupling is in when the coupler head, the electrical contact coupling respectively, is coupled to a complementary configured counter-coupler or complementary configured counter-electrical con-tact coupling respectively. Similarly, the term “normal position” as used herein refers to the position or state in which the coupler head or the electrical contact coupling is in when the coupler head, the electrical contact coupling respectively, is not coupled to a counter-coupler head or a counter-electrical contact coupling respectively.

One preferred realization of the latter embodiment cited, in which the electrical contact coupling is displaceable in the coupling direction of the coupler head relative the coupler head housing, provides for the coupler head housing to be displaceable relative the base body counter to the coupling direction in order to thereby automatically convey the electrical contact coupling mounted to the base body into its coupling position when a predefined or definable minimum force acts on the coupler head housing counter to the coupling direction.

It is hereby conceivable, for example, to provide pretensioning means preferably within the coupler head housing, for example in the form of a spring mechanism, so as to preload the coupler head housing in the coupling direction relative to the base body. Of course this pretensioning means can also be arranged external of the coupler head housing. It is principally an advantage when the preload force, with which the coupler head housing is pretensioned in the coupling direction relative the base body, to be defined by appropriately selecting the spring characteristic to the spring mechanism. This is thus a particularly easy to realize yet effective way to define the minimum force at which the coupler head housing displaces relative the base body counter to the coupling direction so as to convey the electrical contact coupling mounted to the base body into its coupling position.

In one preferred embodiment, the at least one coupler lock of the coupler head comprises a coupling eye which is designed to form a releasable mechanical connection with a coupler lock of a counter-coupler head, and in particular with a hooked plate of a counter-coupler head's coupler lock. Such coupler locks are of general common knowledge in the prior art and particularly established in rail vehicle technology. Hence, well-proven components can be used to form a mechanical connection between the coupler head and the counter-coupler head, which simplifies—and makes particularly cost-effective—the realization of the inventive coupler head.

When—as indicated above—the coupler head housing for the coupler head is displaceable relative the base body counter to the coupling direction so as to convey the electrical contact coupling into its coupling position, it is preferable for at least one opening to be provided in the side of the coupler head housing facing the coupling plane through which the coupling eye of the at least one coupler lock extends when the coupler head housing is in its displaced state relative to the base body counter to the coupling direction. In other words, the coupling eye of the at least one coupler lock extends through the at least one opening provided in the side of the coupler head housing facing the coupling plane when a predefined or definable minimum force acts on the coupler head housing counter to the coupling direction. When, however, there is no force acting on the coupler head housing or a force less than the minimum force in this embodiment, the entire coupler lock is situated within the coupler head housing such that the components of the coupler lock are protected from the effects of weather, etc.

The inventive solution is not limited to the embodiment in which the coupler head housing is displaceable relative the base body counter to the coupling direction in order to convey the electrical contact coupling into its coupling position. In fact, another conceivable example would be providing a displacement mechanism via which the electrical contact coupling is fixed to the base body of the coupler head such that the electrical contact coupling can be displaced in the coupling direction relative to the coupler head housing and relative to the base body to automatically convey the electrical contact coupling into its coupling position after the displacement mechanism has been activated. Thus, in this embodiment, only the electrical contact coupling and not the entire base body together with the at least one coupler lock mounted to said base body is displaced relative to the coupler head housing. Different embodiments are possible as the displacement mechanism. For example, it is conceivable for a coupling mechanism to be triggered after the mechanical connection has been made between the coupler head and a counter-coupler head in order to couple the electrical contact couplings of the coupler head and counter-coupler head.

It is also conceivable for the coupler head housing to be automatically displaced relative the base body counter to the coupling direction upon nearing the counter-coupler head, namely by a component of the counter-coupler head such as e.g. a pin specifically provided for the purpose and pointing toward the coupling plane displacing the coupler head housing of the coupler head relative to the base body of the coupler head counter to the coupling direction upon nearing the counter-coupler head.

In order to effectively prevent any unintentional contacting of the at least one contact pin of the electrical contact coupling when the electrical contact coupling is not in its coupling position (i.e. its normal position), one preferred further development of the inventive solution provides for a guide body made from an electrically insulating material, particularly plastic, which is for example connected to the coupler head housing and guides the movement of the at least one contact pin of the electrical contact coupling relative to the coupler head housing when conveying the electrical contact coupling into its coupling position. The guide body is in particular not just accorded a guiding function but rather also the function of insulating the at least one contact pin when the electrical contact coupling is not in its coupling position; i.e. when the at least one contact pin is displaced relative the coupler head housing counter to the coupling direction. It is preferable in this state for the contact pin to be completely drawn into the guide body, and particularly no area of the contact pin protrude external of the guide body, so as to effectively prevent contact pin short-circuiting or unintentional contacting.

It is additionally an advantage hereto for the at least one contact pin of the electrical contact coupling to exhibit a forward area made of an electrically non-conductive material. This further development ensures that—when the at least one contact pin is displaced relative to the coupler head housing counter to the coupling direction—the forward end of the at least one contact pin which is still accessible from the outside will also be insulated as needed so as to effectively prevent short-circuiting or corrosion. Moreover, since this forward area is electrically insulated, there is no danger should a person come into contact with this front area of the at least one contact pin still accessible from the outside.

A further embodiment of the inventive coupler head moreover provides for a centering device to center the coupler head. The centering device is preferably a mechanical centering device with which the centering of the coupler head ensues by means of at least one spring. Such centering devices are known in the prior art, particularly in the field of rail vehicle technology, and will not be discussed any further herein.

In order to have the coupler head automatically align itself relative to a counter-coupler head when the coupler head nears the counter-coupler head during the coupling process, one preferred realization of the inventive solution provides for alignment. It is hereby conceivable, for example, to provide a centering device for the self-centering of the coupler head and a counter-coupler head to be coupled to the coupler head, whereby centering members of the coupler head come into contact with correspondingly complementary configured centering members of the counter-coupler head during the coupling process. It is for example conceivable to provide a centering pin and a centering sleeve arranged symmetrical to the mirror axis on the front end of the coupler head housing as centering members.

Additionally or alternatively hereto, the coupler head housing can comprise at least one area projecting in the coupling direction which is configured to engage in a receiver of the counter-coupler head configured complementary to the projecting area upon the coupler head nearing the counter-coupler head, thus realizing a self-centering during the coupling process.

A preferred further development of the latter embodiment provides for the projecting area to be centrally arranged on the side of the coupler head housing facing the coupling plane and to exhibit a frustoconical or frustopyramidal geometry. In this embodiment, the electrical contact coupling can be centrally arranged with regard to the upper surface of the frustoconical or frustopyramidal area. Centrally arranging the electrical contact coupling allows a particularly compact design to the coupler head.

It is furthermore preferred with the latter-cited embodiment for the electrical contact coupling to be displaceable relative the coupler head housing, and particularly relative the projecting area of the coupler head housing, in the coupling direction in order to convey the electrical contact coupling into its coupling position when needed, in which at least one contact pin of the electrical contact coupling extends through the upper surface of the frustoconical or frustopyramidal area and projects from the upper surface in the coupling direction such that said at least one contact pin can be received in a socket of an electrical contact coupling of a counter-coupler head configured complementary to said contact pin.

As indicated above, it is particularly preferred with the latter embodiment to further provide a guide body preferably made of an electrically insulating material, in particular plastic, to guide the movement of the at least one contact pin relative to the coupler head housing when the electrical contact coupling is conveyed into its coupling position. In context hereto, the guide body is to be positioned in an opening provided in the upper surface of the frustoconical or frustopyramidal area and connected to the coupler head housing. The guide body thereby has a drill hole running parallel to the coupling direction through which the at least one contact pin extends upon its movement relative to the coupler head housing.

Lastly, particularly with the embodiment of the inventive coupler head in which a projecting area is arranged centrally on the side of the coupler head housing facing the coupling plane, it is preferable to provide a first coupler lock and a second coupler lock, wherein the two coupler locks lie in a common horizontal plane and each are arranged at a lateral spacing from the centrally arranged projecting area. Providing two coupler locks enables a particularly compact configuration to the coupler head, whereby a secure mechanical connection can additionally be realized between the coupler head and a counter-coupler head.

One preferred further development of the inventive solution further provides for the coupler head to not only be able to automatically couple electrical contact terminals of the electrical contact coupling but also pneumatic or hydraulic cables. To this end, a preferred further development provides for the coupler head to comprise a pneumatic/hydraulic line coupling to automatically couple at least one pneumatic or hydraulic line.

The invention further relates to a coupling device for mechanically connecting two units, particularly vehicle units, wherein the coupling device comprises a coupler head of the type described above connected to one of the two units as well as a counter-coupler head connected to the other of the two units, wherein the counter-coupler head comprises at least one coupler lock to form a mechanical connection with the at least one coupler lock of the coupler head as well as an electrical contact coupling configured complementary to the electrical contact coupling of the coupler head.

### BRIEF DESCRIPTION OF THE SEVERAL VIEWS OF THE DRAWING(S)

Exemplary embodiments of the coupler head according to the invention will be described in the following with reference being made to the accompanying drawings.

Shown are:

FIG. 1, a perspective view of an exemplary embodiment of the coupler head according to the invention in its normal position;

FIG. 2, a perspective view of the exemplary embodiment of the coupler head depicted in FIG. 1 in its coupling position;

FIG. 3, a vertical sectional view of the coupler head according to FIG. 1;

FIG. 4, a horizontal sectional view of the coupler head according to FIG. 1;

FIG. 5, a horizontal sectional view of the coupler head according to FIG. 2;

FIG. 6, a perspective view of the base body utilized in the coupler head according to FIG. 1 with mounted components;

FIG. 7, a vertical sectional view of a further exemplary embodiment of a coupler head according to the present invention;

FIG. 8, a horizontal sectional view of the coupler head according to FIG. 7;

FIG. 9, a perspective view of an embodiment of a counter-coupler head which is configured complementary to the coupler head of the present invention;

FIG. 10, a horizontal sectional view of the counter-coupler head according to FIG. 9;

FIG. 11, a perspective view of a coupling device consisting of the coupler head according to the invention and a counter-coupler head according to FIG. 9 in the coupled state;

FIG. 12, a horizontal sectional view through the coupling device according to FIG. 11;

FIG. 13a, a schematic view of the electrical contact couplings of the coupler head according to an embodiment of the present invention as well as an electrical contact coupling of a counter-coupler head according to a further embodiment of the present invention in the uncoupled state; and

FIG. 13b, the electrical contact couplings according to FIG. 13a in the coupled state.

### DETAILED DESCRIPTION

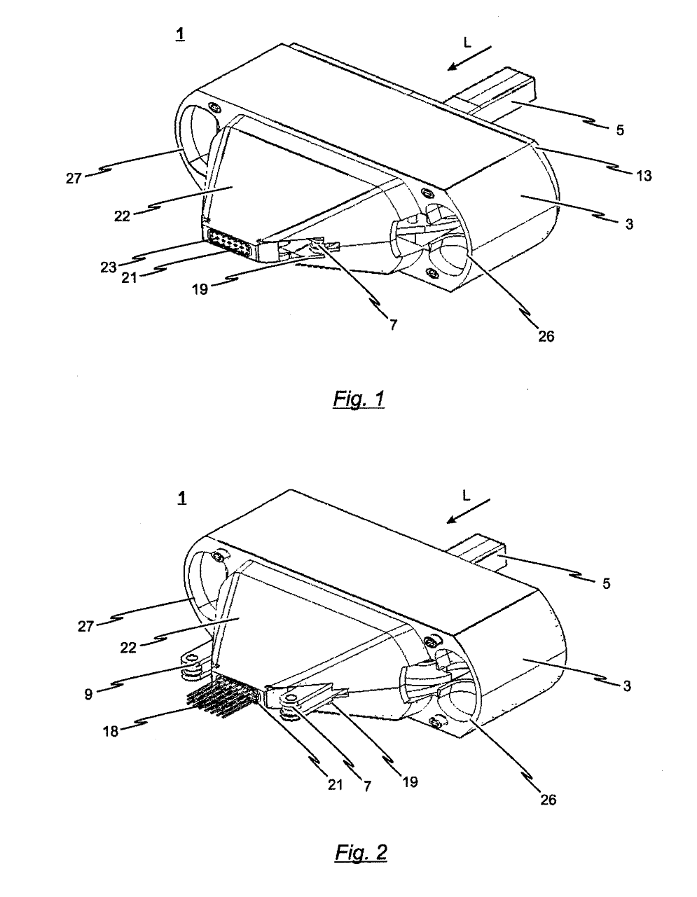

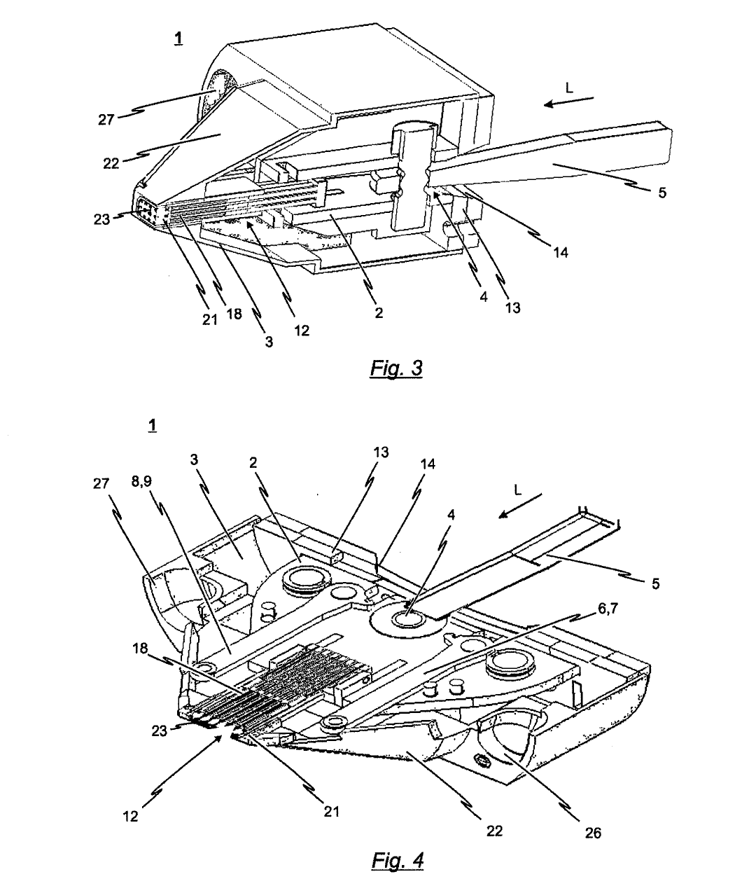

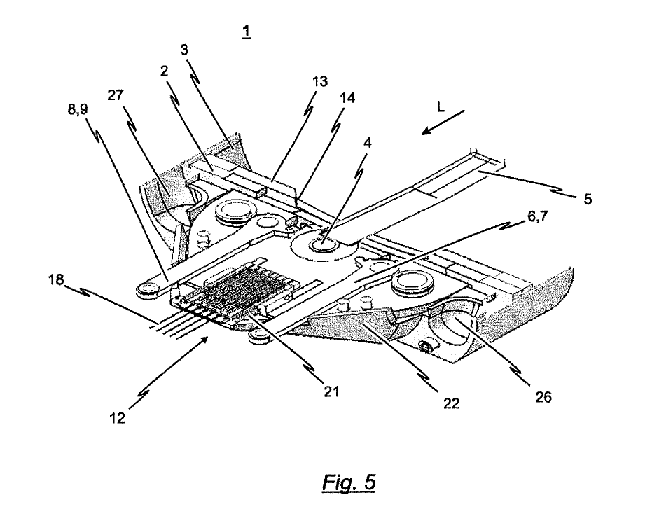

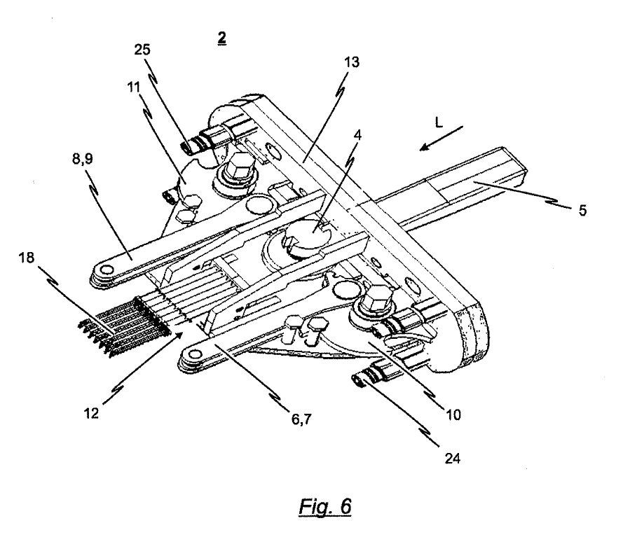

An exemplary embodiment of the inventive coupler head 1 will be described in the following with reference being made to the representations provided in FIGS. 1 to 6. In detail, FIG. 1 depicts a perspective view of the coupler head 1 of this exemplary embodiment when in its normal position. FIG. 2, on the other hand, does show the coupler head 1 in its coupling position in which the contact pins 18 of the electrical contact coupling as well as the coupling eyes 7, 9 of the two coupler locks 6, 8 employed in the coupler head 1 project from the side of the coupler head housing 3 facing the coupling plane. FIGS. 3 and 4 are each sectional representations of the coupler head 1 in its normal position. FIG. 5 shows a horizontal sectional view of the coupler head 1 in its coupling position while FIG. 6 depicts the components mounted to the base body 2 of coupler head 1.

Accordingly, the coupler head 1 according to the first embodiment comprises two coupler locks 6, 8 which each include a hooked plate 10, 11 as well as a coupling eye 7, 9. The hooked plates 10, 11 of the two coupler locks 6, 8 are mounted to a base body 2 of the coupler head 1 so as to be pivotable in a horizontal plane. One coupling eye 7, 9 each engages in the respective hooked plate 10, 11. The coupler locks 6, 8 used in the coupler head 1 according to the depicted embodiment function according to the Scharfenberg principle which is generally known in the field of rail vehicle technology and will not be described any further herein. The coupler head 1 further comprises an electrical contact coupling 12 mounted to the base body 2. The electrical contact coupling 12 comprises a plurality of contact pins 18 to transmit electrical signals or energy.

As can particularly be seen from the sectional representations in FIGS. 3 and 4, the base body 2 with the two coupler locks 6, 8 and the electrical contact coupling 12 are accommodated in a coupler head housing 3. The coupler head housing 3 is limited at it side opposite the coupling plane by a vertical wall (vertically extending area 13) which is fixedly connected to the base body 2 and is part of said base body 2. Thus, both the two coupler locks 6, 8 as well as also the electrical contact coupling 12, and in particular the respective contact pins 18 of the electrical contact coupling 12, are enclosed in coupler head 1 within the coupler head housing 3.

As can further be seen from the representations provided in FIGS. 3 and 4, the base body 2 further comprises a linkage 4 to which a coupling shaft 5 is mounted so as to be pivotable in the horizontal and vertical plane. In detail, the linkage 4 in the embodiment of the inventive coupler head depicted in FIGS. 1 to 6 is configured as a spherical bearing by means of which the coupling shaft 5 is mounted to the base body 2 so as to be pivotable in the horizontal and vertical plane relative to the coupler head 1. This linkage 4 configured as a spherical bearing additionally allows torsional movement of the coupling shaft 5 relative the coupler head 1. The horizontal and vertical pivoting range of the coupler head 1 relative the coupling shaft 5 is defined in the depicted embodiment by a centrally arranged opening 14 in the previously mentioned vertically extending area 13. As indicated above, the vertically extending area 13 defines the side of the base body 2 facing away from the coupling plane.

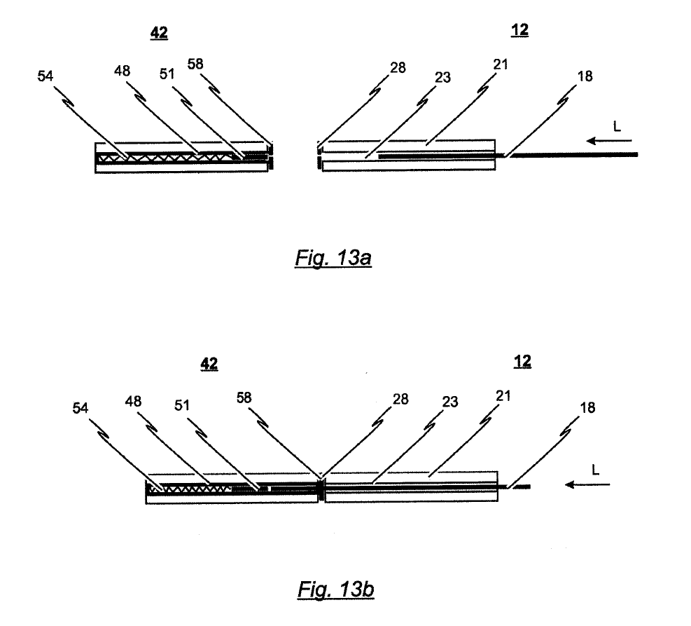

A comparison of the depictions shown in FIGS. 1 and 2 with those of FIGS. 4 and 5 shows that in the inventive solution, the electrical contact coupling 12 is displaceable relative the coupler housing 3 in the coupling direction L of the coupler head 1 so as to convey the electrical contact coupling 12 into its coupling position (cf. FIG. 2 and FIG. 5), in which the contact pins 18 of the electrical contact coupling 12 are at least partly exposed outside of the coupler head housing 3 such that said contact pins 18 can be received in sockets 48 configured complementary to the contact pins 18 of an electrical contact coupling 42 of a counter-coupler head 31. The exact mechanics of interconnecting the contact pins 18 will be described in greater detail in the following with reference being made to the representations provided in FIGS. 13a and 13b.

Specifically, the embodiment of the inventive coupler head 1 depicted in FIGS. 1 to 6 provides for automatically conveying the electrical contact coupling 12 mounted to the base body 2 into its coupling position by coupler head housing 3 being displaceable relative base body 2 counter to coupling direction L. The movement of the coupler head housing 3 relative to the base body 2 occurs in the depicted embodiment of coupler head 1 when a predefined or definable minimum force counter to coupling direction L acts on the coupler head housing 3. This minimum force particularly occurs when the coupler head 1 abuts against a correspondingly complementary configured counter-coupler head 31 during the coupling process. Although not explicitly depicted in the drawings, it is conceivable to provide a pretensioning means, for example in the form of a spring mechanism, preferably inside coupler head housing 3, in order to preload the coupler head housing 3 in the coupling direction L relative to base body 2. The preload force can be defined in a particularly simple to realize manner by appropriately selecting the spring characteristic to the spring mechanism. This preload force in turn defines the minimum force to be applied in order to displace the coupler head housing 3 relative the base body 2 counter to the coupling direction L and convey the electrical contact coupling 12 mounted to the base body 2 into its coupling position.

The solution according to the invention is not limited to the above-described mechanism for displacing the coupler head relative the base body. It is for example also conceivable to provide a displacement mechanism by means of which the electrical contact coupling 12 is mounted to the base body 2, wherein the electrical contact coupling 12 can be displaced relative to the coupler head housing 3 and relative to the base body 2 in coupling direction L upon the displacement mechanism being activated.

As can be noted from the representations provided in FIGS. 2 and 5, not only are the contact pins 18 of the electrical contact coupling 12 exposed outside the coupler head housing 3 in the coupling position of the coupler head 1, but also the front end regions of the above-mentioned coupling eyes 7, 9 of the first and second coupler lock 6, 8. To this end, respective openings 19, 20 are provided in the side of the coupler head housing 3 facing the coupling plane through which extend the front end regions of the coupling eyes 7, 9 of the two coupler locks 6, 8 when the coupler head housing 3 is in its displaced state relative to the base body 2 counter to coupling direction L (see the FIG. 4 depiction).

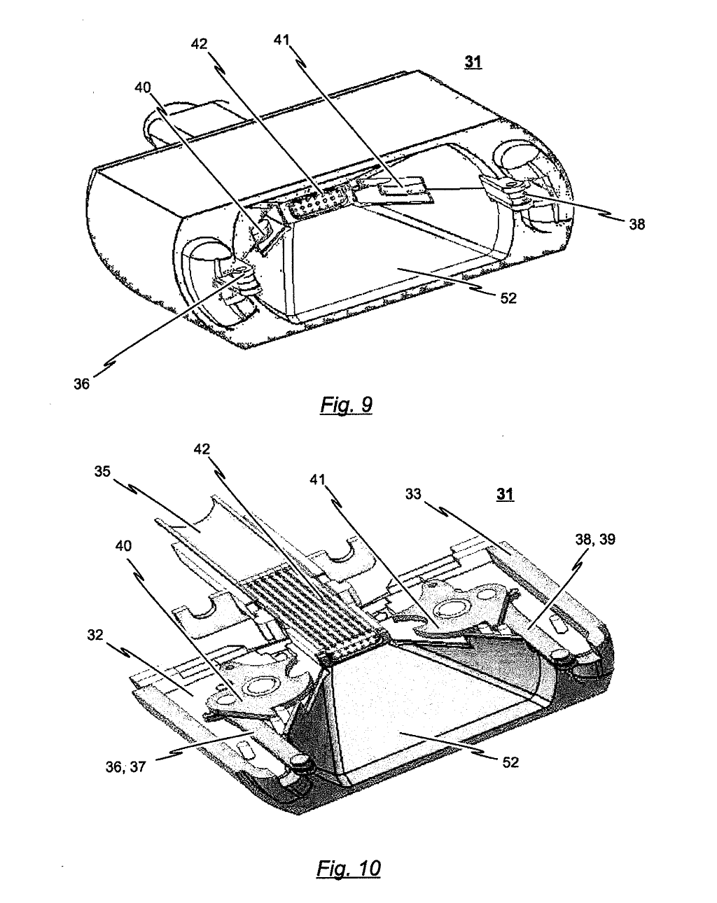

In order to achieve automatic alignment of the coupler head 1 relative a counter-coupler head 31 when said coupler head 1 nears the counter-coupler head 31, the inventive coupler head 1 provides for alignment. In the exemplary embodiment of the coupler head 1, the coupler head housing 3 exhibits an area 22 projecting in coupling direction L hereto which is designed to engage in a receiver 52 of the counter-coupler head 31 configured complementary to the projecting area 22 when coupler head 1 nears counter-coupler head 31. In conjunction hereto, reference is also made to the representation provided in FIG. 12 which shows a horizontal sectional view of a coupling device 100 in which the coupler head 1 in accordance with the representations provided in FIGS. 1 to 5 is coupled to a counter-coupler head 31 in accordance with the representations provided in FIGS. 9 and 10.

The exemplary embodiment of the inventive coupler head 1 is characterized by the area 22 of the coupler head housing 3 projecting in the coupling direction L being centrally arranged on the side of the coupler head housing 3 facing the coupling plane and exhibiting a frustoconical or frustopyramidal geometry. As can be noted particularly from the representations provided in FIGS. 1 to 5, the electrical contact coupling 12 is centrally arranged with respect to the upper surface of the frusto-conical or frustopyramidal area 22 in the exemplary embodiment of inventive coupler head 1.

A comparison of FIGS. 1 and 2 with FIGS. 4 and 5 shows that in the exemplary embodiment of the inventive coupler head 1, the contact pins 18 of the electrical contact coupling 12 in the coupling position of the electrical contact coupling 12 extend through the upper surface of the frustoconical or frustopyramidal area 22 and protrude from the upper surface in coupling direction L such that same can be received in sockets 48 of an electrical contact coupling of a counter-coupler head 31 configured correspondingly complementary thereto (see FIGS. 9 and 10).

The exemplary embodiment of the inventive solution further provides for the coupler head 1 to comprise a total of two pneumatic/hydraulic line couplings 24, 25 for the automatic coupling of pneumatic or hydraulic lines. In conjunction hereto, reference is made to the representation provided in FIG. 6. Specifically, two additional openings 26, 27 are provided on the enlarged areas of the housing in the side of the coupler head housing 3 facing the coupling plane in which the respective line connections for the two line couplings 24, 25 are situated in order to be connectable to correspondingly complementary configured line connections of a counter-coupler head 31 in the coupled state. The enlarged areas of the housing serve in particular to protect the coupling eyes 36, 37, 38, 39 of counter-coupler head 31.

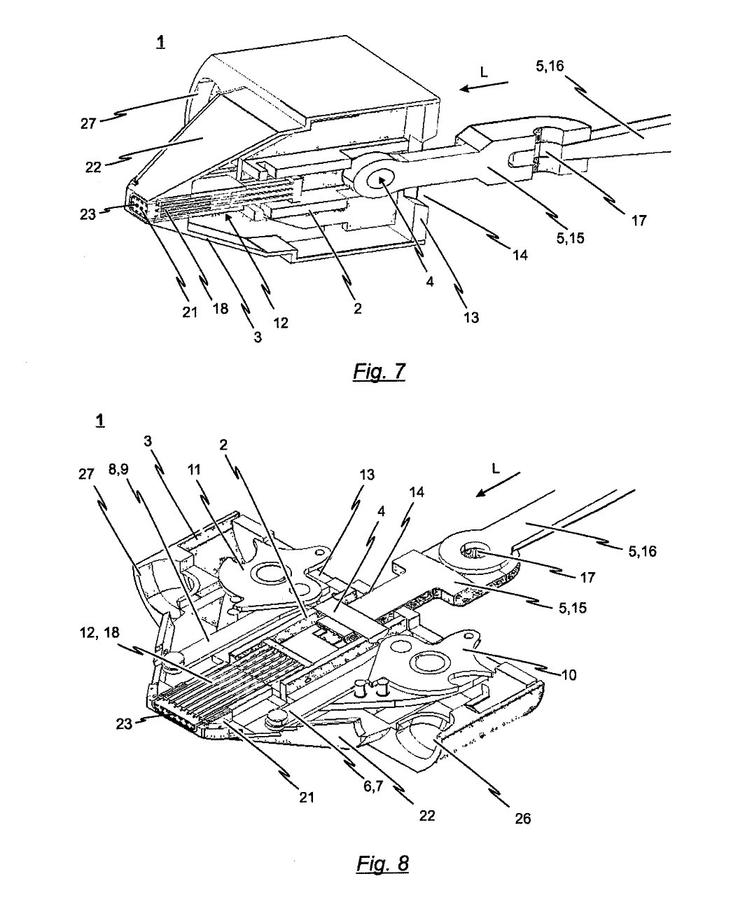

The embodiment of the inventive coupler head 1 depicted in FIGS. 7 and 8 differs from the embodiment depicted with reference to the FIGS. 1 to 6 representations by the design of the linkage 4. Specifically, the embodiment of the linkage 4 depicted in FIGS. 7 and 8 is realized as a swivel joint via which the coupling shaft 5 is mounted to the base body 2 so as to be pivotable in the vertical direction relative the coupler head 1. The embodiment of the coupling shaft 5 depicted in FIGS. 7 and 8 is moreover of two-part configuration and comprises a first shaft section 15 as well as a second shaft section 16 which are pivotably connected relative one another in the horizontal plane by means of an articulation 17. Of course it is however also conceivable in this embodiment for the articulation 17 to be accommodated inside the coupler head housing 3. All that is required hereto is accordingly configuring the coupler head housing 3 to be longer.

FIGS. 9 and 10 depict an exemplary embodiment of a counter-coupler head 31 to which the coupler head 1 according to the present invention can be coupled. In detail, the counter-coupler head 31 likewise comprises two coupler locks 36, 38 which form a mechanical connection with the corresponding coupler locks 6, 8 of coupler head 1 in the coupled state. To this end, the coupler locks 36, 38 of the counter-coupler head 31 each comprise a hooked plate 40, 41 as well as corresponding coupling eyes.

The counter-coupler head 31 further comprises a receiver 52 configured complementary to the projecting area 22 which serves to align the coupler head 1 relative to the counter-coupler head 31 during the coupling process. In contrast to coupler head 1, counter-coupler head 31 can be fixedly connected to the associated vehicle unit. However, it is of course also conceivable to provide a corresponding linkage as that for coupler head 1.

The electrical contact coupling 42 of the counter-coupler head 31 is configured complementary to the electrical contact coupling 12 of coupler head 1 and essentially consists of a plurality of sockets 48 in which the contact pins 18 of the electrical contact coupling 12 of coupler head 1 can be received.

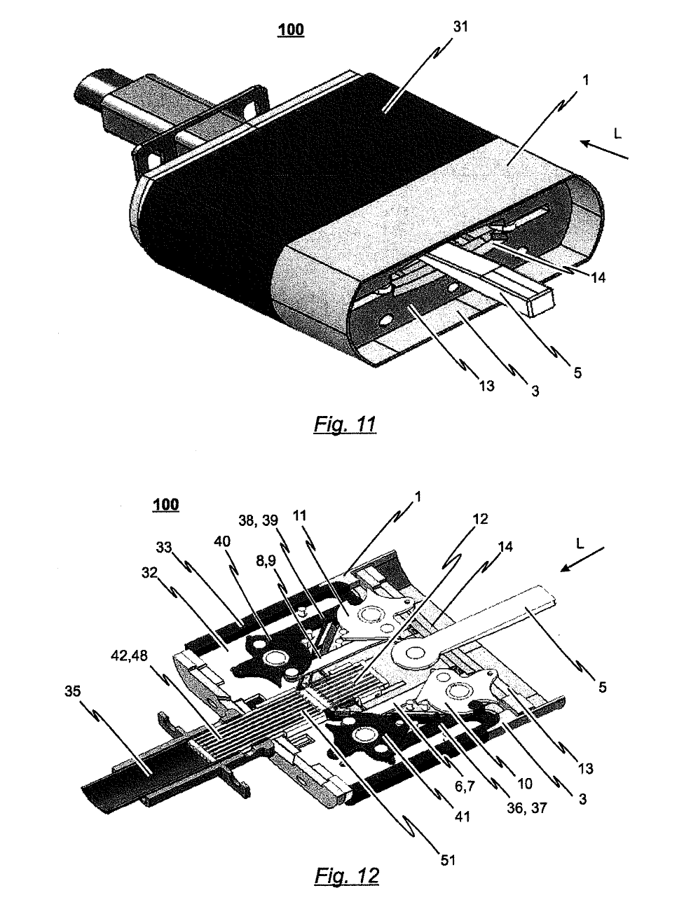

FIGS. 11 and 12 depict respectively perspective views of an embodiment of a coupling device 100 composed of a coupler head 1 in accordance with the present invention as well as a counter-coupler head 31 likewise in accordance with the present invention. As can be noted particularly from the sectional representation of FIG. 12, the respective coupler locks 6, 8 of coupler head 1 on the one hand and the respective coupler locks 36, 38 of counter-coupler head 31 on the other serve to form a mechanical (fixed) connection between the coupler head 1 and the counter-coupler head 31 in the coupled state. The line couplings 24, 25 are not depicted in FIG. 12 merely for the sake of clarity.

The two electrical contact couplings 12, 42 of coupler head 1 as well as counter-coupler head 31, shown in the coupled state in FIGS. 11 and 12, are centrally arranged.

The mechanics of coupling the electrical contact couplings 12, 42 of coupler head 1 and counter-coupler head 42 will be described in the following with reference being made to the representations provided in FIGS. 13a and 13b. FIG. 13a hereby shows the electrical contact coupling 12 of coupler head 1 in its normal position; here the contact pins 18 are not situated external of the coupler head housing 3. A guide body 21 made from an electrically insulating material, particularly plastic, is employed here which is—as can be noted for example from the FIG. 3 depiction—fixedly connected to the coupler head housing 3. This guide body 21 exhibits drill holes 23 running parallel to coupling direction L through which the respective contact pins 18 of the electrical contact coupling 12 of coupler head 1 extend when they move relative to the coupler head housing 3. A seal 28, for example in the form of an O-ring, is provided at the coupling plane-side end section of the guide body 21 in order to seal the drill holes 23 of the guide body 21 off from the exterior and thus protect the respective contact pins 18 of the electrical contact coupling 12 from the effects of weather when the electrical contact coupling 12 of the coupler head 1 is in its normal position.

Meanwhile, the electrical contact coupling 42 of the counter-coupler head 31 comprises sockets 48 configured complementary to the contact pins 18 in which the contact pins 18 can be received in order to be able to couple the electrical lines between the coupler head 1 and the counter-coupler head 31. In order to protect the electrically conductive area of the socket 48 from the effects of weather when the electrical contact coupling 42 is in the uncoupled state and to prevent unintentional contacting of said conductive area, an insulating element 51 mounted so as to be displaceable relative to the socket 48 in coupling direction L is provided in the embodiment of the electrical contact coupling 42 depicted in FIGS. 13a and 13b which is pretensioned toward the coupling plane by means of a spring 54. The end region of the socket 48 is furthermore sealed by means of an O-ring 58.

It is furthermore conceivable for the contact pins 18 of the electrical contact coupling 12 to comprise a forward area made of an electrically non-conductive material. This further development ensures that—when the contact pins 18 are displaced relative to the coupler head housing 3 counter to coupling direction L—the forward end of the contact pins 18 which are still accessible from the outside will also be insulated as needed so that short-circuiting or corrosion is effectively prevented. Moreover, since this forward area is electrically insulated, there is no danger should a person come into contact with this front area of the at least one contact pin 18 still accessible from the outside.

During the coupling process—as already stated above—the contact pins 18 of the electrical contact coupling 12 of coupler head 1 are displaced relative to the coupler head housing 3 and thus also relative to the guide body 21 fixedly connected to the coupler head housing 3 in coupling direction L, in consequence of which the forward area of the contact pins 18 project out of the coupler head housing 3. This thus enables the projecting forward area of the contact pins 18 to be received in the sockets 48 of the electrical contact coupling of the counter-coupler head. To this end, contact pin 18 displaces the insulating element 51 mounted so as to be displaceable relative socket 48 in coupling direction L, enabling the forward area of contact pin 18 to electrically contact the conductive area of socket 48.

The invention is not limited to the embodiments described above with reference to the drawings but rather yields from a synopsis of all the features disclosed herein together.

### LIST OF REFERENCE NUMERALS

1 coupler head
2 base body
3 coupler head housing
4 linkage
5 coupling shaft
6 first coupler lock of the coupler head
7 coupling eye of the first coupler lock (6)
8 second coupler lock of the coupler head
9 coupling eye of the second coupler lock (8)
10 hooked plate of the first coupler lock (6)
11 hooked plate of the second coupler lock (8)
12 electrical contact coupling of the coupler head
13 vertical area of the base body (2)
14 opening in the vertical area of the base body
15 first shaft section
16 second shaft section
17 articulation
18 contact pin
19 opening for the coupling eye (7)
20 opening for the coupling eye (9)
21 guide body
22 projecting area/frustoconical or frustopyramidal area
23 drill hole in guide body (21)
24 line coupling
25 line coupling
26 enlarged housing area/opening for air line coupling (24)
27 enlarged housing area/opening for air line coupling (25)
28 seal/O-ring
31 counter-coupler head
32 base body of the counter-coupler head
33 coupler head housing of the counter-coupler head (31)
35 coupling shaft of the counter-coupler head
36 first coupler lock of the counter-coupler head
37 coupling eye of the first coupler lock (36)
38 second coupler lock of the counter-coupler head
39 coupling eye of the second coupler lock (38)
40 hooked plate of the first coupler lock (36)
41 hooked plate of the second coupler lock (38)
42 electrical contact coupling of the counter-coupler head (31)
48 socket
51 insulating element
52 receiver
54 spring
58 seal/O-ring 100 coupling device
L coupling direction for the coupler head (1)

That which is claimed:

1. A coupler head (1) of a coupling device (100) for mechanically connecting two units, in particular vehicle units, such as two adjacent car bodies of a multi-member vehicle train or a pick-up assembly and the cargo area of a motor vehicle, comprising at least one coupler lock (6, 8) to form a mechanical connection with a coupler lock (36, 38) of a counter-coupler head (31) as well as an electrical contact coupling (12) for the coupling of at least one electrical line between the coupler head (1) and the counter-coupler head (31), wherein the coupler head (1) further comprises the following:
a base body (2) to which the at least one coupler lock (6, 8) and/or the electrical contact coupling (12) is/are mounted; and
a coupler head housing (3) which accommodates the base body (2) with the at least one coupler lock (6, 8) and/or the electrical contact coupling (12); and
wherein the base body (2) comprises a linkage (4) to which a coupling shaft (5) is articulated so as to be pivotable in a horizontal and/or vertical plane.

2. The coupler head (1) according to claim 1, wherein:
on its side opposite from the coupling plane, the base body (2) comprises a vertically extending area (13) having a centrally arranged opening (14) through which the coupling shaft (5) extends; and
the opening (14) defines the pivoting range of the coupler head (1) relative to the coupling shaft (5).

3. The coupler head (1) according to claim 1, wherein:
the linkage (4) is realized as a spherical bearing by means of which the coupling shaft (5) is articulated to the base body (2) so as to be pivotable in a horizontal as well as vertical plane relative to the coupler head (1); and
the spherical bearing further allows torsional movement of the coupling shaft (5) relative the coupler head (1).

4. The coupler head (1) according to claim 1, wherein:
the linkage (4) is realized as a swivel joint by means of which the coupling shaft (5) is articulated to the base body (2) so as to be pivotable in a horizontal or vertical plane relative to the coupler head (1); and
the coupling shaft (5) comprises a first shaft section (15) and a second shaft section (16) which are connected together by means of an articulation (17) so as to be pivotable relative one another in a vertical or horizontal plane.

5. The coupler head (1) according to claim 1, wherein the electrical contact coupling (12) is displaceable relative the coupler head housing (3) in the coupling direction (L) of the coupler head (1) so that the electrical contact coupling (12) can be conveyed into its coupling position in which at least one contact pin (18) of the electrical contact coupling (12) is at least partly exposed outside of the coupler head housing (3) such that it can be received in a socket (48) of an electrical contact coupling (12) of a counter-coupler head (31) configured complementary to said contact pin (18).

6. The coupler head (1) according to claim 5, wherein:
the coupler head housing (3) is displaceable relative the base body (2) counter to coupling direction (L) in order for the electrical contact coupling (12) mounted to the base body (2) to be automatically conveyed into its coupling position when a predefined or definable minimum force acts on the coupler head housing (3) counter to coupling direction (L); and
a spring mechanism is provided to preload the coupler head housing (3) in the coupling direction (L) relative base body (2), wherein the preload force is definable by appropriately selecting the spring characteristic to the spring mechanism.

7. The coupler head (1) according to claim 6, wherein:
the at least one coupler lock (6, 8) comprises a coupling eye (7, 9) which is designed to form a releasable mechanical connection with a coupler lock (36, 38) of a counter-coupler head (31), and in particular with a hooked plate (40, 41) of a coupler lock (36, 38) of a counter-coupler head (31); and
at least one opening (19, 20) is provided in the side of the coupler head housing (3) facing the coupling plane through which the coupling eye (7, 9) of the at least one coupler lock (6, 8) extends when the coupler head housing (3) is in its displaced state relative to the base body (2) counter to coupling direction (L).

8. The coupler head (1) according to claim 5, wherein the electrical contact coupling (12) is mounted to the base body (2) by means of a displacement mechanism such that the electrical contact coupling (12) is displaceable relative to the coupler head housing (3) and relative to the base body (2) in coupling direction (L) in order for the electrical contact coupling (12) to be automatically conveyed into its coupling position after said displacement mechanism has been activated.

9. The coupler head (1) according to claim 4, wherein a guide body (21) is further provided, made from an electrically insulating material, in particular plastic, to guide the movement of the at least one contact pin (18) relative to the coupler head housing (3) when the electrical contact coupling (12) is conveyed into its coupling position.

10. The coupler head (1) according to claim 1, wherein:
a centering device is further provided to center the coupler head (1); and
the centering device is a mechanical centering device, which makes use of at least one spring to center the coupler head (1).

11. The coupler head (1) according to claim 1, wherein:
an alignment is further provided to align the coupler head (1) relative to a counter-coupler head (31) upon the coupler head (1) nearing the counter-coupler head (31); and
the coupler head housing (3) comprises at least one area (22) projecting in coupling direction (L) hereto which is configured to engage in a receiver (52) of the counter-coupler head (31) configured complementary to said projecting area (22) upon the coupler head (1) nearing the counter-coupler head (31).

12. The coupler head (1) according to claim 11, wherein:
the projecting area (22) is centrally arranged on the side of the coupler head housing (3) facing the coupling plane and exhibits a frustoconical or frustopyramidal geometry, and
the electrical contact coupling (12) is centrally arranged with regard to the upper surface of the frustoconical or frustopyramidal area (22).

13. The coupler head (1) according to claim 12, wherein the electrical contact coupling (12) is displaceable relative to the coupler head housing (3), and in particular relative to the projecting area (22) of the coupler head housing (3) in coupling direction (L) so that the electrical contact coupling (12) will be conveyed into its coupling position in which at least one contact pin (18) of said electrical contact coupling (12) extends through the upper surface of the frustoconical or frustopyramidal area (22) and projects from the upper surface in coupling direction (L).

14. The coupler head (1) according to claim 13, wherein a guide body (21) made of an electrically insulating material, in particular plastic, is further provided to guide the movement of the at least one contact pin (18) relative to the coupler head housing (3) when the electrical contact coupling (12) is conveyed into its coupling position, wherein the guide body (21) is positioned in an opening provided in the upper surface of the frustoconical or frustopyramidal area (22) and connected to the coupler head housing (3), and wherein the guide body (21) has a drill hole (23) running parallel to the coupling direction (L) through which the at least one contact pin (18) extends upon its movement relative to the coupler head housing (3).

15. The coupler head (1) according to claim 13, wherein the least one contact pin (18) comprises a forward area made of an electrically non-conductive material.

16. The coupler head (1) according to claim 13, wherein a first coupler lock (6) and a second coupler lock (8) are provided, wherein the two coupler locks (6, 8) lie in a common horizontal plane and each are arranged at a lateral spacing from the centrally arranged projecting area (22).

17. The coupler head (1) according to claim 1, wherein:
a pneumatic/hydraulic line coupling (24, 25) is further provided to automatically couple at least one pneumatic or hydraulic line;
the pneumatic/hydraulic line coupling (24, 25) comprises at least one pneumatic/hydraulic line connection mounted to the base body (2) which is displaceable together with said base body (2) relative to the coupler head housing (3) in coupling direction (L); and
at least one opening (26, 27) is provided in the side of the coupler head housing (3) facing the coupling plane in which the at least one pneumatic/hydraulic line connection is situated or through which the at least one pneumatic/hydraulic line connection extends when the coupler head housing (3) is in its displaced state relative the base body (2) counter coupling direction (L).

18. A coupling device (100) for mechanically connecting two units, particularly vehicle units, such as two adjacent car bodies of a multi-member vehicle train or a pick-up assembly and the cargo area of a motor vehicle, wherein the coupling device (100) comprises a coupler head (1) in accordance with claim 1 connected to one of the two units as well as a counter-coupler head (31) connected to the other of the two units, wherein the counter-coupler head (31) comprises at least one coupler lock (36, 38) to form a mechanical connection with the at least one coupler lock (6, 8) of the coupler head (1) as well as an electrical contact coupling (42) configured complementary to the electrical contact coupling (12) of coupler head (1).

19. The coupling device (100) according to claim 18, wherein:
the electrical contact coupling (12) of coupler head (1) is displaceable relative to the coupler head housing (3) of coupler head (1) in the coupling direction (L) of said coupler head (1) in order to convey the electrical contact coupling (12) of said coupler head (1) into its coupling position in which at least one contact pin (18) of the electrical contact coupling (12) is at least partly exposed outside of said coupler head housing (3) such that it can be received in a socket (48) of the electrical contact coupling (42) of counter-coupling head (31) configured complementary to said contact pin (18);
an insulating element (51) mounted in the socket (48) of the electrical contact coupling (42) of counter-coupler head (31) so as to be displaceable in coupling direction (L) relative said socket (48) is provided which is displaced upon contact pin (18) of electrical contact coupling (12) of coupler head (1) being received in the socket (48) of the electrical contact coupling (42) of the counter-coupler head (31) counter to the coupling direction of said counter-coupler head; and
the at least one contact pin (18) of the electrical contact coupling (12) comprises a forward area made of an electrically non-conductive material.
